(19) United States
(12) Patent Application Publication
(10) Pub. No.: US 2019/0039464 A1
(43) Pub. Date: Feb. 7, 2019

(54) PRIMARY-SIDE CHARGING DEVICE, SECONDARY-SIDE CHARGING DEVICE AND METHOD OF CHARGING A BATTERY FOR A VEHICLE HAVING AN ELECTRIC DRIVE

(71) Applicant: FEAAM GmbH, Neubiberg (DE)

(72) Inventors: Andreas GREIFELT, Muenchen (DE); Christian ROTH, Feldkirchen (DE)

(21) Appl. No.: 16/051,351

(22) Filed: Jul. 31, 2018

(30) Foreign Application Priority Data
Aug. 1, 2017 (DE) 102017117418.4

(51) Int. Cl. B60L 11/18; H02J 7/02; H02J 50/10

(52) U.S. Cl. CPC B60L 11/182; H02J 7/025; B60L 2200/32; B60L 11/1825; B60L 2200/10; H02J 50/10

(57) ABSTRACT

A primary-side charging device (10) is disclosed for charging a battery (11) for a vehicle (12) having an electric drive (37). The primary-side charging device (10) comprises at least one primary coil (13) and a primary-side charging module (14) in which the primary coil (13) is arranged. The primary-side charging module (14) has at least three side surfaces (15) and each of the side surfaces (15) encloses an angle of greater than 0° and not more than 90° with a base area of the primary-side charging module (14). In addition, the at least one primary coil (13) is connected to a power supply unit (16). Furthermore, a secondary-side charging device (19) for charging a battery (11) for a vehicle (12) having an electric drive (37), a charging system (24) and a method of charging a battery (11) for a vehicle (12) having an electric drive (37) are disclosed.

The present specification relates to a primary-side charging device for charging a battery for a vehicle having an electric drive, a secondary-side charging device for charging a battery for a vehicle having an electric drive, and a method of charging a battery for a vehicle having an electric drive.

Vehicles having an electric drive, such as electric cars, may have a battery to supply power. To charge the battery, it can be connected to another battery or a power grid, for example. Since the battery has a high capacity, charging times are often very long. This reduces the comfort for the user and calls for a higher number of charging stations.

One object to be achieved is to specify a primary-side charging device for the efficient charging of a battery for a vehicle having an electric drive. Another object to be achieved is to specify a secondary-side charging device for the efficient charging of a battery for a vehicle having an electric drive. Another object to be achieved is to specify an efficient method of charging a battery for a vehicle having an electric drive.

The objects are achieved by the subject-matter of the independent claims. Advantageous designs and further developments are indicated in the dependent claims.

According to at least one embodiment of the primary-side charging device for charging a battery for a vehicle having an electric drive, the primary-side charging device comprises at least one primary coil. The at least one primary coil may have a large number of windings. It is also possible that the primary coil has at least only one winding. The primary coil may have a round or rectangular cross-section. A magnetically conductive material may be arranged in the primary coil, for example an iron core.

According to at least one embodiment, the primary-side charging device comprises at least two primary coils. It is also possible that the primary-side charging device has six primary coils or that the primary-side charging device has eight primary coils.

The vehicle having an electric drive may be a land vehicle, such as a car or bus, or an aircraft, such as an aeroplane, or a watercraft, such as a boat, ship or submarine. It is possible that the electric drive is the only drive of the vehicle. It is also possible that the vehicle comprises the electric drive and at least one other drive. The drive of a vehicle may be an engine. The drive of a vehicle allows the vehicle to move. The vehicle having an electric drive could be an electric car, for example. The vehicle battery may be a traction battery.

The primary-side charging device also includes a primary-side charging module in which the primary coil is arranged. For example, the primary-side charging module is arranged to transfer energy to a secondary-side charging module in a charging position during charging. For example, the primary-side charging device may be a permanently installed charging station for charging a battery of a vehicle having an electric drive. For example, the primary-side charging device may be located in or under a floor plate on which the vehicle may be located, or in a device next to an area in which the vehicle may be located.

The primary-side charging module has at least three side surfaces and each of the side surfaces encloses an angle of greater than 0° and not more than 90° with a base area of the primary-side charging module. The primary-side charging module may have the shape of a three-dimensional body. Each of the side surfaces may be adjacent to the base area of the primary-side charging module and each of the side surfaces may be adjacent to two of the side surfaces. This means that each side surface may have a shared side with the base area of the primary-side charging module and each of the side surfaces can have a shared side with two of the side surfaces.

For example, the primary-side charging module may have the shape of a pyramid with at least three side surfaces. In this case, the base area of the pyramid forms the base area of the primary-side charging module. The base area of the primary-side charging module may have the shape of a polygonal chain with three or more sides. For a very large number of sides of the base area, the base area takes approximately the shape of a circle. In this case, the primary-side charging module may have the shape of a cone.

The side surfaces of the primary-side charging module may be side surfaces of a housing in which the at least one primary coil is arranged.

If the angle between the side surfaces and the base area of the primary-side charging module is 90°, the primary-side charging module may have the shape of a prism with at least three lateral surfaces. If the angle between the side surfaces and the base area of the primary-side charging module is less than 90°, the primary-side charging module may have the shape of a three-dimensional body with tapered side surfaces.

It is also possible that the at least three side surfaces of the primary-side charging module form side surfaces of a recess in the primary-side charging module. In this case, the recess may have the shape of a pyramid, cone or prism. Here, the base area of the primary-side charging module forms the base area of the recess. In this case, the base area of the recess is an imaginary surface which closes the recess.

According to at least one embodiment, each of the side surfaces encloses an angle of greater than 0° and less than 90° with a base area of the primary-side charging module.

According to at least one embodiment, each of the side surfaces encloses an angle of greater than 55° and not more than 90° with a base area of the primary-side charging module.

According to at least one embodiment, each of the side surfaces encloses an angle of greater than 55° and less than 90° with a base area of the primary-side charging module.

If the primary-side charging module has more than one primary coil, each primary coil may be located adjacent or close to any of the side surfaces in the primary-side charging module. If the primary-side charging module has only one primary coil, the primary coil may be located adjacent or close to any of the side surfaces in the primary-side charging module.

The primary-side charging module may have at least two different segments. For example, a primary coil is arranged in each of the segments. The primary coils of each segment can be controlled individually. For example, the primary-side charging module may have six segments.

Furthermore, the at least one primary coil is connected to a power supply unit. The power supply unit may be a battery or a power grid. A power electronic unit for adapting the electrical variables may be located between the power supply unit and the primary coil. The primary coil may be connected directly to the power grid or to a back-up battery. A power factor correction module including a back-up battery may be arranged between the connection to the power grid and the primary coil, which allows charging with better efficiency.

The vehicle battery can be charged by inductively coupling the at least one primary coil to at least one secondary coil of a secondary charging device. The secondary-side charging device may be located in the vehicle. The battery is therefore not charged via a direct electrical contact between the primary-side charging module and the secondary-side charging device, but via a wireless transmission of electrical power. For this purpose, each primary coil may be connected to a converter, for example an inverter or a DC-AC converter, which converts the DC voltage of the power supply unit into an AC voltage. During charging, the electromagnetic field generated by the primary coil induces an alternating voltage in the secondary coil. This voltage can be converted into a DC voltage by a converter in the secondary-side charging device, for example a rectifier or an AC-DC converter. This DC voltage can be used to charge the vehicle battery.

The primary-side charging module may also be arranged to take energy from a secondary-side charging module in a charging position.

The primary-side charging device described allows the efficient transmission of electrical power, for example in the range between 20 kW and 800 kW. Thus, the charging time can be shortened. The transmitted power preferably is at least 150 kW and at most 600 kW. Advantageously, higher electrical power can be transmitted if the primary-side charging device has at least two primary coils and the secondary-side charging device has at least two secondary coils. With a larger number of primary and secondary coils the charging time can be further reduced.

Since no charging cable is required to transmit the electrical power, the primary-side charging device is more robust against failures due to a cable break. In addition, the comfort for charging the battery is increased as no cable needs to be connected to the vehicle. For example, the charging process can be performed in a semi-automated or automated manner, which further increases convenience for a user. Safety is increased because no electrical contacts are exposed due to the inductive coupling. In addition, the primary-side charging device is independent of moisture influences.

Furthermore, the arrangement of the at least three side surfaces of the primary-side charging module allows several primary coils to be arranged in the primary-side charging module and that the primary-side charging module can be designed to be as compact as possible at the same time. By arranging one primary coil per side surface, several primary coils can be arranged in the primary-side charging module. If the side surfaces have an angle of less than 90° to the base area of the primary-side charging module, several primary coils can be compactly arranged in the primary-side charging module.

According to at least one embodiment, the primary-side charging module has a shape which is complementary to a secondary-side charging module. The secondary-side charging module may be part of a secondary-side charging device. For example, the primary-side charging module may be a three-dimensional body with at least three side surfaces. In this case, the secondary-side charging module may have the shape of a recess so that the primary-side charging module can be arranged in the recess. The primary-side module is arranged in such a way that an air gap remains between the primary-side charging module and the secondary-side charging module while the battery is being charged. It is also possible that the primary-side charging module has the shape of a recess so that the secondary-side charging module can be arranged in the recess. In this case, the secondary-side charging module may have the shape of a three-dimensional body.

For example, the air gap may have a width of at least 0.1 mm and at most 15 mm. It is also possible that the air gap has a maximum width of 5 mm. The air gap can be as thin as desired. The width of the air gap is the shortest connection between a side surface of the primary-side charging module and a side surface of the secondary-side charging module. The width of the air gap thus indicates the distance between the primary-side charging module and the secondary-side charging module. The specified values for the width of the air gap may apply to the entire side surfaces of the primary-side charging module and the secondary-side charging module. For the specified widths of the air gap, the efficiency of the energy transfer from the primary-side charging module to the secondary-side charging module is increased.

The fact that the primary-side charging module has a shape complementary to the secondary-side charging module can mean that the primary-side charging module and the secondary-side charging module engage each other with a positive fit except for an air gap arranged between the primary-side charging module and the secondary-side charging module. In each case, one of the two charging modules has the shape of a three-dimensional body and the other of the two charging modules has the shape of a recess in which the three-dimensional body can be arranged. It is also possible that the primary-side charging module and the secondary-side charging module are in direct contact in places, so that the air gap is present only in places and not everywhere between the primary-side charging module and the secondary-side charging module.

While charging the vehicle battery, electrical power can be transmitted from a primary coil to a secondary coil. An imaginary connecting axis between the primary coil and the secondary coil preferably encloses an angle with the base area of the primary-side charging module of more than 0° and not more than 90°. It is also possible that the connecting axis between the primary coil and the secondary coil encloses an angle with the base area of the primary-side charging module of greater than 55° and not more than 90°. In both cases, the electromagnetic scattering is reduced during energy transfer.

According to at least one embodiment, the at least three side surfaces of the primary-side charging module form side surfaces of a truncated pyramid or truncated cone. This means that the primary-side charging module may have the shape of a truncated pyramid or the shape of a truncated cone. The primary-side charging module has a surface which extends parallel to the base area of the primary-side charging module. Thus, each of the side surfaces encloses an angle of at least 90° and less than 180° with the surface of the primary-side charging module. Since the primary-side charging module may have the shape of a truncated pyramid or a truncated cone, it can be made to be particularly compact. This means that the secondary-side charging module of the vehicle can also be made to be particularly compact.

According to at least one embodiment, each primary coil can be separately controlled by the power supply unit. For this purpose, each primary coil can be connected to its own converter. A converter may be an inverter, a DC-AC converter, a rectifier or an AC-DC converter. In addition, the primary-side charging device may have a first charging control device. The first charging control device may include a power factor correction circuit or a rectifier circuit to maximize the active power for the primary-side charging module. Furthermore, the first charging control device has one converter for each primary coil. The converter may be an inverter, for example. The operating frequency of the converter may be at least 30 kHz and at most 150 kHz. It is also possible that the operating frequency of the converter is at least 80 kHz and not more than 90 kHz. This means that the primary coils can be designed to be as small as possible.

The operating frequency can be varied by ±5 kHz for each individual converter. It is also possible to vary the operating frequency for each individual converter by ±1 kHz. Thus, the primary coils can each be operated at different frequencies. In this way, for example, efficiency-reducing harmonic oscillations can be minimized. It is also possible that one or more of the primary coils are not being operated or that the amplitudes of the alternating current at the primary coils are different. This allows a partial load operation in which the charging power is reduced. The primary-side charging device can be operated in the partial load operation, for example, when the vehicle battery is already almost fully charged, or in order to adapt the charging process to other requirements or to the requirements of a user, such as the costs of the charging process.

According to at least one embodiment, the primary-side charging device comprises at least two primary-side charging modules so that the batteries of at least two vehicles can be charged. The at least two primary-side charging modules can be connected to the same power supply unit.

According to at least one embodiment, a cooling module is arranged in the primary-side charging module. The cooling module may be arranged adjacent to the surface of the primary-side charging module. The cooling module can be designed such that a liquid or gaseous coolant can flow through it. For this purpose, the cooling module may have a plug contact to which a supply line for the coolant can be connected. The coolant may be a cooling fluid or a cooling gas, for example. It is also possible that the cooling module comprises several cooling sub-modules. The coolant can flow through each of the cooling sub-modules. It is also possible for a liquid or gaseous heat medium to flow through the cooling module.

While charging the vehicle battery, the cooling module may be in direct contact with a contact area of the secondary-side charging module. This means that the cooling module and the contact area can be in thermal contact during charging. The contact area may be designed to be in thermal contact with the vehicle battery and to cool or heat it. The thermal contact with the cooling module allows the vehicle battery to be heated or cooled to an optimum temperature for charging the battery. In very warm weather conditions, for example, the battery can be cooled, and in very cold weather conditions the battery can be heated. This allows the battery to be charged efficiently. It is also possible that the contact area is in thermal contact with other components of the secondary-side charging device, such as cables or power electronics, to cool or heat them.

According to at least one embodiment, the primary-side charging device has an adjusting part which comprises the primary-side charging module, wherein the adjusting part can be moved in at least one adjustment direction. The adjusting part may be connected to a motor or actuators so that the adjusting part can be moved. The adjusting part may have an extendable axle on which the primary-side charging module is arranged. For example, the adjusting part can be moved in an adjustment direction so that the primary-side charging module is positioned such that the vehicle battery can be charged efficiently. For example, the adjustment direction may be perpendicular to a base plate on which the vehicle is positioned during charging. It is also possible that the adjustment direction is parallel or at an angle to the base plate. Furthermore, it is possible that the adjusting part can be moved in two further directions, both perpendicular to the adjustment direction. It is also possible that the adjusting part can be rotated about an axis, for example around the adjustment direction, or that the adjusting part can be tilted. This enables precise positioning of the primary-side charging module for charging the vehicle battery.

The at least three side surfaces of the primary-side charging module may be arranged such that each of the side surfaces encloses an angle of at least 0° and less than 90° relative to the adjustment direction of the adjusting part.

If the primary-side charging module has several segments, it is possible that each of the segments is moved separately with the adjusting part. Therefore, individual segments may be positioned to charge the vehicle battery and other segments may remain further away from the secondary-side charging module. Thus, the power to be transmitted can be varied.

The motor or the actuators of the adjusting part can be operated automatically, so that the primary-side charging module can be positioned automatically. For this purpose, the motor or the actuators can be controlled by a first charging control device. For this purpose, the first charging control device may be an electronic, a program-controlled or a flow-controlled control device, which may have a microcontroller or a “Field Programmable Gate Array” (FPGA). The first charging control device is able to control the motor or the actuators for instance on the basis of determined sensor signals according to an adjustment algorithm. For this purpose, various sensors may be located in the primary-side charging device or in the secondary-side charging device or in both charging devices. The sensors may be, for example, light barriers, contact switches, load sensors or inductive sensors. For example, the sensor signals can indicate the positions of the primary coil and the secondary coil. The sensor signals can be transmitted via the inductive coupling between the primary coil and the secondary coil. It is also possible that the sensor signals are transmitted in a different way. It is further possible that the motor or the actuators of the adjusting part are controlled by a second charging control device of the secondary-side charging device.

The sensors can also be used to detect a movement of the secondary-side charging device during charging. In this case, the primary-side charging module can be removed from the secondary-side charging module so that the charging modules are not damaged due to the movement of the secondary-side charging device. This increases safety while charging the battery.

According to at least one embodiment, the primary-side charging module is automatically positioned for charging the vehicle battery. An AC voltage can be applied to the at least one primary coil. In the secondary-side charging device the direct current can be measured, which is generated due to the inductive coupling of the primary coil with a secondary coil. The desired position for charging the battery then depends on the measured direct current. Another possibility is to determine the load current of the primary-side charging device. As soon as a secondary coil is near a primary coil, the load current increases. In this case, the desired position for charging the battery depends on the measured load current. The adjusting device can be moved until the desired position is reached. This process can be performed in an automatic or semi-automatic manner. It is also possible that this process is controlled by a user.

Due to the geometric shape of the primary-side charging module and the secondary-side charging module, both charging modules may undergo a mechanically caused self-centering process.

Prior to the charging process, it is also possible to check the level of the maximum permissible charging performance of the secondary-side charging device. The power transmitted by the primary-side charging device and the number of the segments of the primary-side charging device which are used to transmit the power may be adapted to this.

According to at least one embodiment, the primary-side charging device comprises a parking aid for the vehicle. For this purpose, for example, adjustment devices may be arranged in a base plate so that the vehicle can be moved to the charging position with the aid of the adjustment devices.

According to at least one embodiment, data can be transferred between the primary-side charging device and the secondary-side charging device. During the charging process, for example, data can be transmitted to the secondary coil as high-frequency components in the alternating current in the primary coil. It is also possible that during the charging process data are transmitted to the primary coil as high-frequency components in the alternating current in the secondary coil. Furthermore, data can be transmitted wirelessly, for example via radio signals or Bluetooth, or via a cable. The data transmitted may include, for example, information on the state of charge or temperature of the battery, information to identify the secondary charging device or information to determine the cost of charging the battery or other costs. Media data such as music or videos may be transferred as well.

According to at least one embodiment, the at least one primary coil has a different number of windings than at least one secondary coil. Thus, the primary coil and the secondary coil can be transformer-coupled. At a fixed voltage of the primary-side charging device, it is possible to transfer energy to a secondary-side charging device which is operated at a different voltage than the primary-side charging device when the numbers of windings of the primary coil and the secondary coil differ. The primary-side charging device can therefore be used for different vehicles regardless of their voltage level.

The disclosure also relates to a secondary-side charging device for charging a battery for a vehicle having an electric drive. The secondary-side charging device can be used with a primary-side charging device described here to charge a battery for a vehicle having an electric drive.

According to at least one embodiment of the secondary-side charging device for charging a battery for a vehicle having an electric drive, the secondary-side charging device comprises at least one secondary coil. The at least one secondary coil may have a large number of windings. It is also possible that the secondary coil has at least one winding. The secondary coil may have a round or rectangular cross-section. A magnetically conductive material may be arranged in the secondary coil, for example an iron core.

According to at least one embodiment, the secondary-side charging device comprises at least two secondary coils. It is also possible that the secondary-side charging device has six secondary coils or that the secondary-side charging device has eight secondary coils.

The vehicle having an electric drive may be a land vehicle, such as a car or bus, or an aircraft, such as an aeroplane, or a watercraft, such as a boat, a ship or a submarine. It is possible that the electric drive is the only drive of the vehicle. It is also possible that the vehicle comprises the electric drive and at least one other drive. The drive of a vehicle may be an engine. The drive of a vehicle allows the vehicle to move. The vehicle having an electric drive may be an electric car, for example.

The secondary-side charging device further comprises a secondary-side charging module in which the secondary coil is arranged. For example, the secondary-side charging module is arranged to take up energy from a primary-side charging module in a charging position during charging. The secondary-side charging device may be located in the vehicle, for instance.

The secondary-side charging module has at least three side surfaces and each of the side surfaces encloses an angle of greater than 0° and not more than 90° with a base area of the secondary-side charging module. The secondary-side charging module may have the shape of a three-dimensional body. Each of the side surfaces may be adjacent to the base area of the secondary-side charging module and each of the side surfaces may be adjacent to two of the side surfaces. This means that each of the side surfaces may have a shared side with the base area of the secondary-side charging module and each of the side surfaces may have a shared side with two of the side surfaces.

By way of example, the secondary-side charging module may have the shape of a pyramid with at least three side surfaces. In this case, the base area of the pyramid forms the base area of the secondary-side charging module. The base area of the secondary-side charging module may have the shape of a polygon chain with three or more sides. For a very large number of sides of the base area, the base area takes the shape of a circle. In this case, the secondary-side charging module may have the shape of a cone.

The side surfaces of the secondary-side charging module may be side surfaces of a housing in which the at least one secondary coil is arranged.

If the angle between the side surfaces and the base area of the secondary-side charging module is 90°, the secondary-side charging module may have the shape of a prism with at least three lateral faces. If the angle between the side surfaces and the base area of the secondary-side charging module is less than 90°, the secondary-side charging module may have the shape of a three-dimensional body with tapered side surfaces.

For example, the secondary-side charging module may be located on an outer surface of the vehicle. It is also possible that the secondary-side charging module is located on the underside of the vehicle.

It is also possible that the at least three side surfaces of the secondary-side charging module form side surfaces of a recess in the secondary-side charging module. In this case, the recess may have the shape of a pyramid, cone or prism. In this case, the base area of the secondary-side charging module forms the base area of the recess. Here, the base area of the recess is an imaginary surface which closes the recess. The recess may be located on an external surface or on the underside of the vehicle. In this case, the secondary-side charging device is located in the vehicle and further has the recess.

According to at least one embodiment, each of the side surfaces encloses an angle of greater than 0° and less than 90° with a base area of the secondary-side charging module.

According to at least one embodiment, each of the side surfaces encloses an angle of greater than 55° and not more than 90° with a base area of the secondary-side charging module.

According to at least one embodiment, each of the side surfaces encloses an angle of greater than 55° and less than 90° with a base area of the secondary-side charging module.

If the secondary-side charging module has more than one secondary coil, each secondary coil may be located adjacent or close to any of the side surfaces in the secondary-side charging module. If the secondary-side charging module has only one secondary coil, the secondary coil may be arranged adjacent to or close to any of the side surfaces in the secondary-side charging module.

The secondary-side charging module may have at least two different segments. For example, a secondary coil is arranged in each of the segments. The secondary coils of each segment can be controlled individually. For example, the secondary-side charging module may have six segments.

Furthermore, the at least one secondary coil is electrically coupled to the vehicle battery. The secondary coil may be connected, for instance, to a converter which is connected to the battery. A converter may be an inverter, a DC-AC converter, a rectifier or an AC-DC converter. The coupling of the secondary coil with the battery enables the transmission of electrical power from the secondary coil to the battery.

The vehicle battery can be charged by inductively coupling the at least one secondary coil to at least one primary coil of a primary-side charging device. The primary-side charging device may be located outside the vehicle. The battery is therefore not charged via a direct electrical contact between the primary-side charging device and the secondary-side charging device, but via a wireless transmission of electrical power. For this purpose, each primary coil can be connected to a converter, for example an inverter or a DC-AC converter, which converts the DC voltage of a power supply unit into an AC voltage. During charging, the electromagnetic field generated by the primary coil induces an alternating voltage in the secondary coil. This voltage can be converted into a DC voltage by a converter in the secondary-side charging device, for example a rectifier or an AC-DC converter. This DC voltage can be used to charge the vehicle battery.

The secondary-side charging module may also be arranged to transfer energy to a primary-side charging module in a charging position.

The described secondary-side charging device allows the efficient transmission of electrical power, for example in the range between 20 kW and 800 kW. Thus, the charging time can be shortened. Preferably, the transmitted power is at least 150 kW and at most 600 kW. Advantageously, higher electrical power can be transmitted if the primary-side charging device has at least two primary coils and the secondary-side charging device has at least two secondary coils. With a larger number of primary and secondary coils, the charging time can be further reduced.

Since no charging cable is required to transmit the electrical power, the secondary-side charging device is more robust against failures. In addition, the comfort for charging the battery is increased as no cable needs to be connected to the vehicle. For example, the charging process can be performed in a semi-automated or automated manner, which further increases convenience for a user. The safety is increased because no electrical contacts are exposed due to the inductive coupling. In addition, the secondary-side charging device is independent of moisture influences.

Furthermore, the arrangement of the at least three side surfaces of the secondary-side charging module allows several secondary coils to be arranged in the secondary-side charging module and that the secondary-side charging module can be designed to be as compact as possible at the same time. By arranging one secondary coil per side surface, several secondary coils can be arranged in the secondary-side charging module. If the side surfaces have an angle of less than 90° to the base area of the secondary-side charging module, several secondary coils can be compactly arranged in the secondary-side charging module.

According to at least one embodiment, the secondary-side charging module has a shape which is complementary to a primary-side charging module. The primary-side charging module can be part of a primary-side charging device. For example, the secondary-side charging module may be a three-dimensional body with at least three side surfaces. In this case, the primary-side charging module may have the form of a recess so that the secondary-side charging module can be arranged in the recess. The secondary-side module is arranged here such that an air gap remains between the primary-side charging module and the secondary-side charging module while the battery is being charged. It is also possible that the secondary-side charging module has the form of a recess so that the primary-side charging module can be arranged in said recess. In this case, the primary-side charging module may have the shape of a three-dimensional body.

The air gap may have a width of at least 0.1 mm and at most 15 mm, for instance. It is also possible that the air gap has a maximum width of 5 mm. The air gap can be as thin as desired. The width of the air gap is the shortest connection between a side surface of the primary-side charging module and a side surface of the secondary-side charging module. The width of the air gap thus indicates the distance between the primary-side charging module and the secondary-side charging module. The specified values for the width of the air gap may apply to all side surfaces of the primary-side charging module and the secondary-side charging module. For the specified widths of the air gap, the efficiency of the energy transfer from the primary-side charging module to the secondary-side charging module is increased.

The fact that the secondary-side charging module has a shape which is complementary to the primary-side charging module can mean that the secondary-side charging module and the primary-side charging module engage each other with a positive fit except for an air gap which is located between the primary-side charging module and the secondary-side charging module. In each case, one of the two charging modules has the shape of a three-dimensional body and the other of the two charging modules has the shape of a recess in which the three-dimensional body can be arranged. It is also possible that the primary-side charging module and the secondary-side charging module are in direct contact in places, so that the air gap exists in places between the primary-side charging module and the secondary-side charging module.

While charging the vehicle battery, electrical power can be transmitted from a primary coil to a secondary coil. An imaginary connecting axis between the primary coil and the secondary coil preferably encloses an angle with the base area of the primary-side charging module of more than 0° and at most 90°. It is also possible that the connecting axis between the primary coil and the secondary coil encloses an angle with the base area of the primary-side charging module of greater than 55° and not more than 90°. In both cases, electromagnetic scattering is reduced during energy transmission.

According to at least one embodiment, the at least three side surfaces of the secondary-side charging module form side surfaces of a truncated pyramid or truncated cone. This means that the secondary-side charging module may have the shape of a truncated pyramid or the shape of a truncated cone. The secondary-side charging module has a surface which extends parallel to the base area of the secondary-side charging module. Thus, each of the side surfaces encloses an angle of at least 90° and less than 180° with the surface of the secondary-side charging module. Since the secondary-side charging module may have the shape of a truncated pyramid or truncated cone, it can be designed to be particularly compact. This means that the primary-side charging module can also be made to be particularly compact.

According to at least one embodiment, each secondary coil is coupled to a converter. During charging, the electromagnetic field generated by the primary coil induces an alternating voltage in the secondary coil. This voltage can be converted by the converter in the secondary-side charging device, for example a rectifier or an AC-DC converter, into a DC voltage. This DC voltage can be used to charge the vehicle battery.

According to at least one embodiment, the secondary-side charging module has a contact area which is thermally coupled to the battery. The contact area may be located adjacent to the surface of the secondary-side charging module. The contact area may be designed to be in thermal contact with the vehicle battery and to cool or heat it. It is also possible that the contact area is in thermal contact with other components of the secondary-side charging device, such as cables or power electronics, to cool or heat them.

While charging the vehicle battery, the contact area may be in direct contact with a cooling module of the primary-side charging module. This means that the cooling module and the contact area can be in thermal contact during charging. The thermal contact with the cooling module allows the vehicle battery to be heated or cooled to an optimum temperature for charging the battery. In very warm weather conditions, for example, the battery can be cooled and in very cold weather conditions, the battery can be heated. This allows the battery to be charged efficiently.

According to at least one embodiment, the secondary-side charging device has an adjusting part which comprises the secondary-side charging module, wherein the adjusting part can be moved in at least one adjustment direction. The adjusting part can be connected to a motor or to actuators so that the adjusting part can be moved. The adjusting part can have an extendable axle on which the secondary-side charging module is arranged. For example, the adjusting part can be moved in an adjustment direction so that the secondary-side charging module is positioned such that the vehicle battery can be charged efficiently. For example, the adjustment direction can be perpendicular to a base plate on which the vehicle is positioned during charging. It is also possible that the adjustment direction is parallel or at an angle to the base plate. Furthermore, it is possible that the adjusting part can be moved in two further directions, both perpendicular to the adjustment direction. It is also possible that the adjusting part can be rotated about an axis, for example around the adjustment direction, or that the adjusting part can be tilted. This enables a precise positioning of the secondary-side charging module for charging the vehicle battery.

The at least three side surfaces of the secondary-side charging module may be arranged such that each of the side surfaces encloses an angle of at least 0° and less than 90° relative to the adjustment direction of the adjusting part.

If the secondary-side charging module has several segments, it is possible that each of the segments is separately moved with the adjusting part. Therefore, individual segments can be positioned to charge the vehicle battery and other segments can remain further away from the primary-side charging module. Thus, the power to be transmitted can be varied.

The motor or the actuators of the adjusting part can be operated automatically, so that the secondary-side charging module can be positioned automatically. For this purpose, the motor or the actuators can be controlled by a second charging control device. To this end, the second charging control device may be an electronic, a program-controlled or a flow-controlled control device, which may have a microcontroller or a “Field Programmable Gate Array” (FPGA). The second charging control device can control the motor or the actuators, for example on the basis of determined sensor signals according to an adjustment algorithm. For this purpose, various sensors may be located in the primary-side charging device or in the secondary-side charging device or in both charging devices. The sensors may be, for example, light barriers, contact switches, load sensors or inductive sensors. By way of example, the sensor signals can indicate the positions of the primary coil and the secondary coil. The sensor signals can be transmitted via the inductive coupling between the primary coil and the secondary coil. It is also possible that the sensor signals are transmitted in a different way. It is also possible that the motor or the actuators of the adjusting part are controlled by a first charging control device of the primary-side charging device.

The sensors can also be used to detect a relative movement between the secondary-side charging device and the primary-side charging device during charging. In this case, the secondary-side charging module can be removed from the primary-side charging module so that the charging modules are not damaged due to the movement of the secondary-side charging device. This increases safety while charging the battery.

Due to the geometric shape of the primary-side charging module and the secondary-side charging module, both charging modules may undergo a mechanically caused self-centering process.

It is also possible to position the secondary-side charging module for charging by moving the vehicle, for example by the vehicle drive. In this case it is not necessary for the secondary-side charging device to have an adjusting part.

According to at least one embodiment, data can be transferred between the primary-side charging device and the secondary-side charging device. During the charging process, for example, data can be transmitted to the secondary coil as high-frequency components in the alternating current in the primary coil. It is also possible that during the charging process data are transmitted to the primary coil as high-frequency components in the alternating current in the secondary coil. Furthermore, data can be transmitted wirelessly, for example via radio signals or Bluetooth, or via a cable. The data transmitted may include, for example, information on the state of charge or the temperature of the battery, information to identify the secondary charging device or information to determine the cost of charging the battery or other costs. Media data such as music or videos can be transferred as well.

According to at least one embodiment, the secondary-side charging device has a parking aid for the vehicle. For example, the secondary-side charging device can control the vehicle drive and automatically position the vehicle in a position for charging the battery.

According to at least one embodiment, the at least one secondary coil has a different number of windings than at least one primary coil. Thus, the primary coil and the secondary coil can be transformer-coupled. At a fixed voltage of the primary-side charging device, it is possible to transfer energy to a secondary-side charging device which is operated at a different voltage than the primary-side charging device when the numbers of windings of the primary coil and the secondary coil differ. The primary-side charging device can therefore be used for different vehicles regardless of their voltage level.

The disclosure also relates to a charging system for charging a battery for a vehicle having an electric drive. The charging system comprises a primary-side charging device described here and a secondary-side charging device described here. Thus, all features of the described primary-side charging device and the described secondary-side charging device are also disclosed for the charging system, and vice versa.

According to at least one embodiment of the charging system, an air gap remains between the primary-side charging module and the secondary-side charging module during charging the battery. The air gap is an air gap as described above.

According to at least one embodiment of the charging system, the at least one primary coil has a different number of windings than the at least one secondary coil. This means, for example, that the winding ratio between primary coil and secondary coil is not equal to 1.

According to at least one embodiment of the charging system, the cooling module and the contact area are in thermal contact while the battery is being charged.

Furthermore, a method of charging a battery for a vehicle having an electric drive is disclosed.

According to at least one embodiment of the method of charging a battery for a vehicle having an electric drive, the method comprises the step of positioning a primary-side charging module having at least one primary coil and a secondary-side charging module having at least one secondary coil. The primary-side charging module may be a primary-side charging module described here and the secondary-side charging module may be a secondary-side charging module described here. Thus, all features of the described primary-side charging module and the described secondary-side charging module are also disclosed for the method of charging a battery for a vehicle having an electric drive, and vice versa.

The primary-side charging module and the primary coil can be components of a primary-side charging device described here. The secondary-side charging module and the secondary coil can be components of a secondary-side charging device described here.

In a subsequent method step, an AC voltage is applied to the at least one primary coil. For this purpose, the primary coil can be connected to a converter. The converter can convert a DC voltage provided by a back-up battery or a power grid into an AC voltage.

In a further method step, an AC voltage induced in the at least one secondary coil is converted into a DC voltage for charging the battery. For this purpose, the secondary coil can be connected to a converter.

The vehicle battery can be charged by inductively coupling the at least one primary coil to at least one secondary coil of a secondary charging device. The secondary-side charging module can be located in the vehicle. The battery is therefore not charged via a direct electrical contact between the primary-side charging module and the secondary-side charging module, but via a wireless transmission of electrical power. For this purpose, each primary coil can be connected to a converter, for example an inverter or a DC-AC converter, which converts the DC voltage of the power supply unit into an AC voltage. During charging, the electromagnetic field generated by the primary coil induces an alternating voltage in the secondary coil. This voltage can be converted into a DC voltage by a converter in the secondary-side charging device, for example a rectifier or an AC-DC converter. This DC voltage can be used to charge the vehicle battery.

In this process, the at least one primary coil is connected to a power supply unit and the at least one secondary coil is electrically coupled to the vehicle battery. Furthermore, the primary-side charging module has at least three side surfaces and each of the side surfaces encloses an angle of greater than 0° and not more than 90° with a base area of the primary-side charging module, and the secondary-side charging module has at least three side surfaces and each of the side surfaces encloses an angle of greater than 0° and not more than 90° with a base area of the secondary-side charging module. Furthermore, the side surfaces of the primary-side charging module are adapted to the side surfaces of the secondary-side charging module so that an air gap remains between the primary-side charging module and the secondary-side charging module during charging the battery.

According to at least one embodiment of the method, a cooling module is arranged in the primary-side charging module and a contact area is arranged in the secondary-side charging module, the contact area being thermally coupled to the battery or other components of the secondary-side charging device, and the cooling module and the contact area being in thermal contact during charging the battery.

The primary-side charging device described here, the secondary-side charging device, the charging system and the method of charging a battery for a vehicle having an electric drive will be explained in more detail below with the aid of exemplary embodiments and the associated figures.

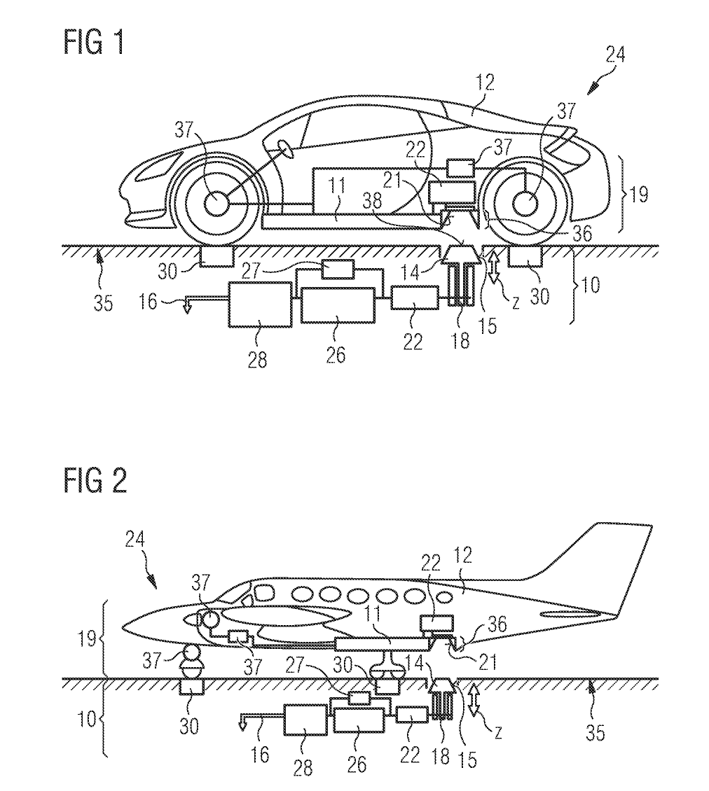

FIGS. 1, 2, 3, 4 and 5 show exemplary embodiments of the charging system comprising the primary-side charging device and the secondary-side charging device. FIG. 1 also explains the method described here in more detail.

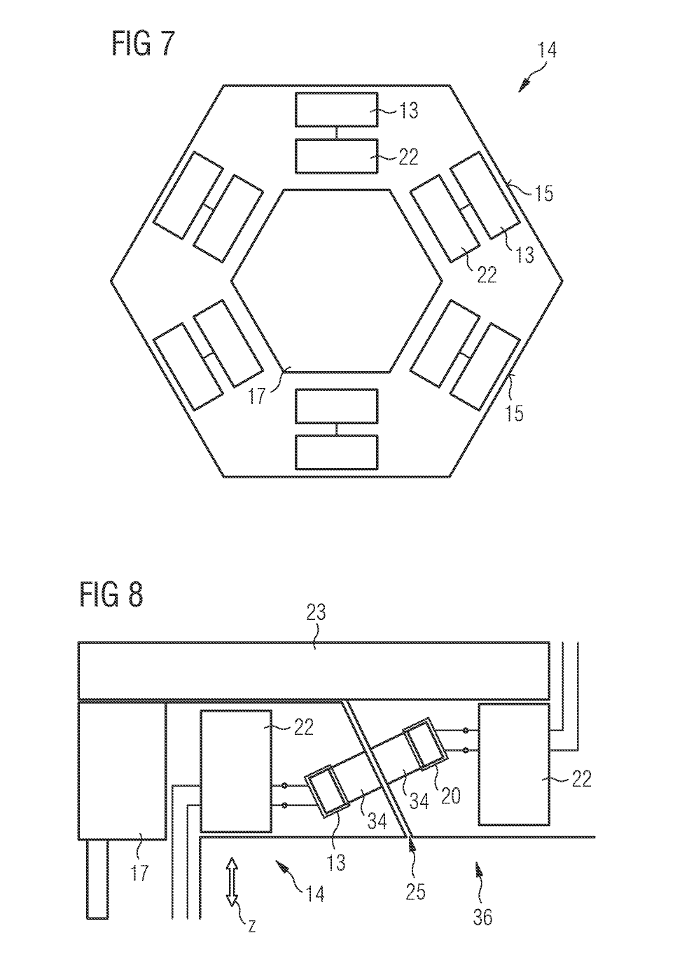

FIGS. 6 and 7 show schematic sectional views of an exemplary embodiment of a primary-side charging module.

FIG. 8 shows a part of an exemplary embodiment of the primary-side charging module and a part of an exemplary embodiment of the secondary-side charging module.

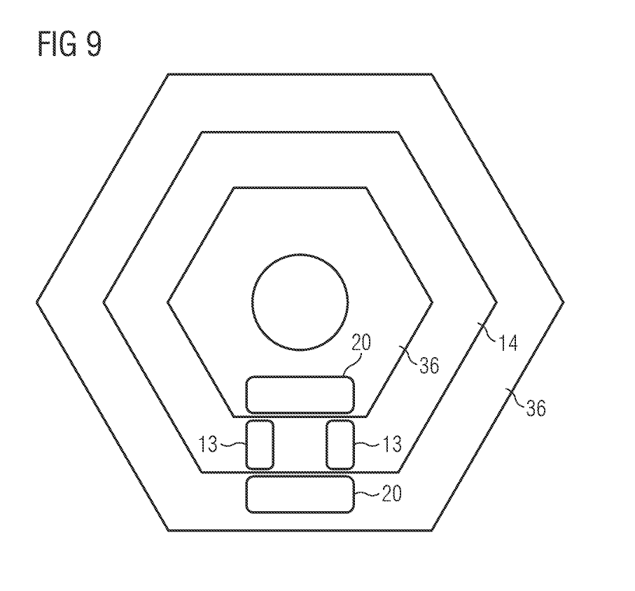

FIG. 9 shows a part of another exemplary embodiment of the primary-side charging module and a part of another exemplary embodiment of the secondary-side charging module.

FIG. 1 shows an exemplary embodiment of a charging system 24, which comprises a primary-side charging device 10 and a secondary-side charging device 19. The secondary-side charging device 19 and a battery 11 are arranged in a vehicle 12. The vehicle 12 is arranged on a base plate 35. The primary-side charging device 10 is located below the base plate 35. The primary-side charging device 10 comprises a primary-side charging module 14. At least one primary coil 13 is arranged in the primary-side charging module 14. The primary side charging module 14 has the shape of a truncated pyramid with at least three side surfaces 15 and a surface 38. Each of the side surfaces 15 encloses an angle of greater than 0° and not more than 90° with a base area of the primary-side charging module 14. In this embodiment, the base area of the primary-side charging module 14 is parallel to the main direction of extension of the base plate 35.

The primary-side charging device 10 also has an adjusting part 18. The adjusting part 18 comprises the primary-side charging module 14 and can be moved in an adjustment direction z. The adjustment direction z is perpendicular to the main direction of extension of the base plate 35. Thus, the primary-side charging module 14 can be moved toward the vehicle 12 by moving the adjusting part 18.

The primary-side charging device 10 also has a converter 22 to which the at least one primary coil 13 is connected. In addition, the primary-side charging device 10 has a back-up battery 26 with an automatic control 27 connected in parallel and a first charging control device 28. The first charging control device 28 is connected to a power supply unit 16. The first charging control device 28 is also connected to the back-up battery 26. The back-up battery 26 is connected to the converter 22. For example, the power supply unit 16 may be a power grid or another battery. The first charging control device 28 may include a power factor correction circuit or a rectifier circuit to maximize the active power for the primary-side charging module 14. The converter 22 may be a DC-AC converter, for example. If the primary-side charging module 14 has more than one primary coil 13, each primary coil 13 is connected to its own transformer 22.

Furthermore, the primary-side charging device 10 comprises two adjustment devices 30, which can be used to move the vehicle 12 to a position for charging the battery 11.

The secondary-side charging device 19 comprises a secondary-side charging module 36. At least one secondary coil 20 is arranged in the secondary-side charging module 36. The secondary-side charging module 36 has the shape of a recess with at least three side surfaces 21. The three side surfaces 21 form the side surfaces of a truncated cone. Each of the side surfaces 21 encloses an angle of greater than 0° and not more than 90° with a base area of the secondary-side charging module 36. In this exemplary embodiment, the base area of the secondary-side charging module 36 is parallel to the main direction of extension of the base plate 35, and the secondary-side charging module 36 has a shape which is complementary to the primary-side charging module 14.

Each of the secondary coils 20 is connected to its own converter 22 of the secondary-side charging device 19. The converter 22 is connected to the battery 11 of the vehicle 12. The battery 11 is connected to a drive 37 of the vehicle 12 and is located in the area of the floor of the vehicle 12.

For charging the battery 11 of the vehicle 12, the primary-side charging module 14 is approached to the secondary-side charging module 36 until a charging position is reached. For this purpose, the surface 38 of primary-side charging module 14 may be in direct contact with the vehicle 12. An air gap 25 remains between the side surfaces 15 of the primary-side charging module 14 and the side surfaces 21 of the secondary-side charging module 36 during charging. As soon as the charging position is reached, an AC voltage is applied to the at least one primary coil 13. For this purpose, the DC voltage provided by the back-up battery 26 is converted by the converter 22 into an AC voltage. An electromagnetic field is generated by the alternating voltage applied to the primary coil 13, which induces an alternating voltage in the secondary coil 20. This voltage is converted by the converter 22 of the secondary-side charging device 19 into a DC voltage with which the battery 11 of the vehicle 12 is charged.

In FIG. 1, the vehicle 12 is a land vehicle or a car.

FIG. 2 shows another exemplary embodiment of the charging system 24. The primary-side charging device 10 is arranged stationary under a base plate 35. The secondary-side charging device 19 is located in an aircraft or aeroplane. The setup of the primary-side charging device 10 and secondary-side charging device 19 is as shown in FIG. 1.

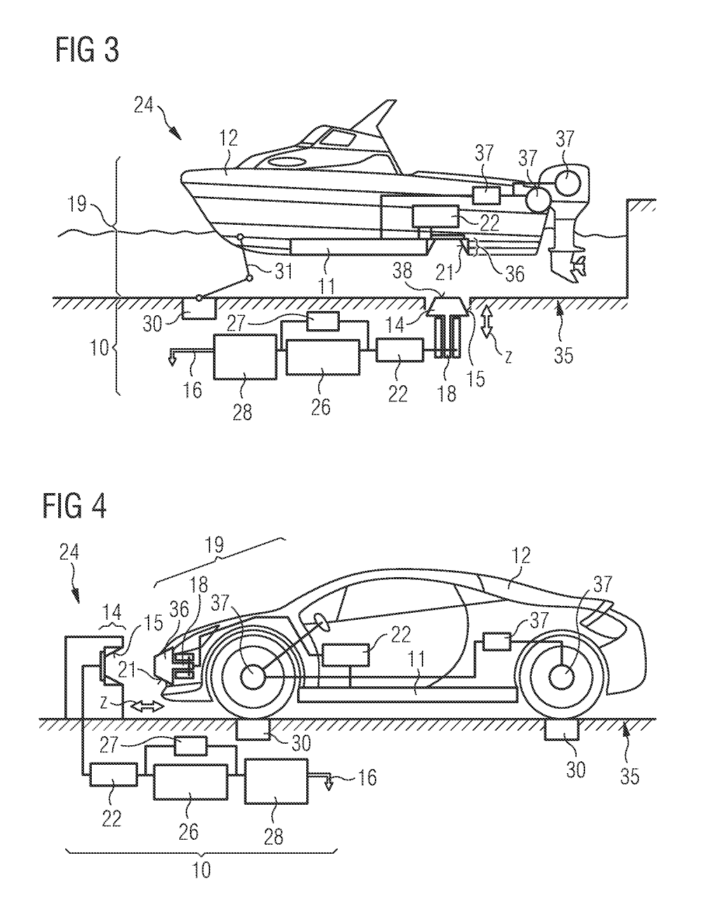

FIG. 3 shows another exemplary embodiment of the charging system 24. The primary-side charging device 10 is arranged stationary under a base plate 35. The secondary-side charging device 19 is arranged in a vessel or boat. The setup of the primary-side charging device 10 and the secondary-side charging device 19 is as shown in FIG. 1. In addition, an adjusting device 30 of the primary-side charging device 10 is connected to a connecting arm 31. The connecting arm 31 is also connected to the vehicle 12. This allows the vehicle 12, even when in water, to be held in a fixed position during charging by being connected to the connecting arm 31.

FIG. 4 shows another exemplary embodiment of the charging system 24. The primary-side charging device 10 is arranged stationary under a base plate 35 and above the base plate 35. The secondary-side charging device 19 is arranged in a land vehicle 12 as shown in FIG. 1. In contrast to the structure in FIG. 1, the primary-side charging module 14 has the shape of a recess. The side surfaces 15 of the primary-side charging module 14 enclose an angle of greater than 0° and less than 90° with the base plate 35. The secondary-side charging module 36 has the shape of a three-dimensional body, in this case the shape of a truncated pyramid. The secondary-side charging device 19 has an adjusting part 18, which comprises the secondary-side charging module 36. The adjusting part 18 can be moved in an adjustment direction z, which extends parallel to the main direction of extension of the base plate 35. Thus, the secondary-side charging module 36 for charging the battery 11 can be approached to the primary-side charging module 14 by means of the adjusting part 18. The side surfaces 21 of the secondary-side charging module 36 enclose an angle of greater than 0° and less than 90° with the adjustment direction z.

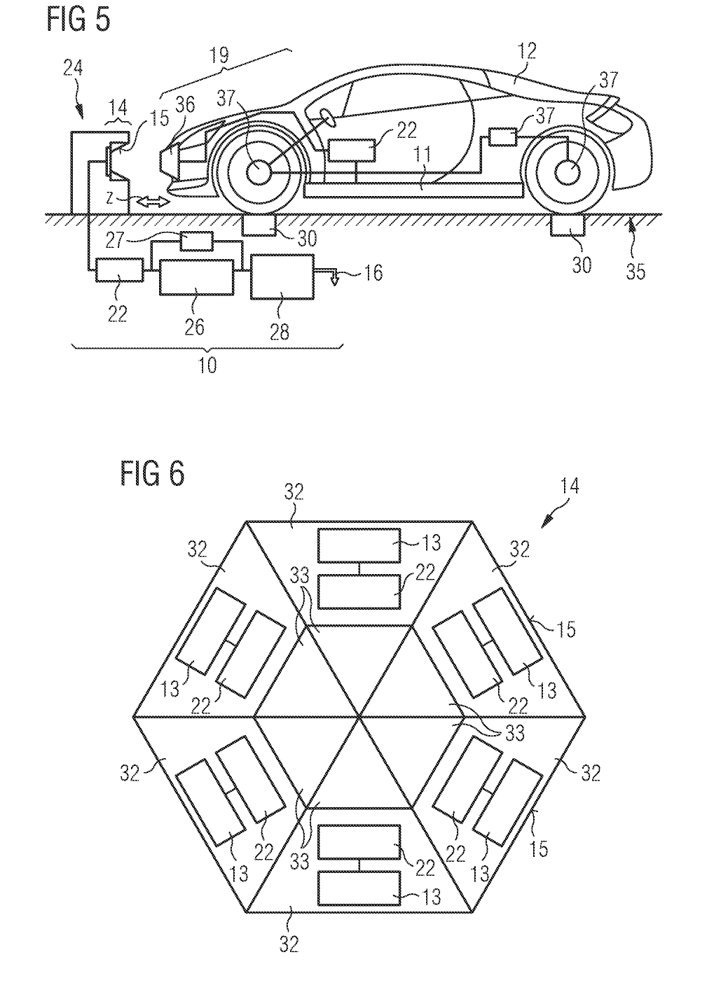

FIG. 5 shows a further exemplary embodiment of the charging system 24. The setup of the primary-side charging device 10 is the same as shown in FIG. 4. The setup of the secondary-side charging device 19 differs from the setup shown in FIG. 4 in that the secondary-side charging device 19 has no adjusting part 18. The entire vehicle 12 is moved in the adjustment direction z to approach the secondary-side charging module 36 to the primary-side charging module 14. The drive 37 of the vehicle 12 or the adjustment devices 30 can be used for this purpose.

FIG. 6 shows a schematic sectional view of an exemplary embodiment of the primary-side charging module 14. The primary-side charging module 14 has six primary coils 13. The base area of the primary-side charging module 14 is a hexagon with six equal sides. Thus, the primary-side charging module 14 has six side surfaces 15. Each of the primary coils 13 is arranged adjacent to one of the side surfaces 15. Instead of one primary coil 13, several primary coils 13 per side surface 15 may also be arranged in the primary-side charging module 14. In addition, each of the primary coils 13 is connected to a converter 22. Furthermore, the primary-side charging module 14 has six cooling sub-modules 33. Each of the cooling sub-modules 33 is arranged on one side of a primary coil 13 which faces away from the respective side surface 15. Thus, the cooling sub-modules 33 adjoin each other in the middle of the base area of the primary-side charging module 14. The primary-side charging module 14 is divided into six segments 32. Each of the segments 32 comprises a primary coil 13, a converter 22 and a cooling sub-module 33. Each of the segments 32 can be moved and controlled separately. It is also possible to apply AC voltages of different amplitude or frequency to the primary coils 13.

FIG. 7 shows a schematic sectional view of another exemplary embodiment of the primary-side charging module 14. The design of the primary-side charging module 14 is similar to FIG. 6 with the difference that the primary-side charging module 14 is not divided into segments 32. The primary coils 13 and the converters 22 are arranged as shown in FIG. 6. Instead of six cooling sub-modules 33, the primary-side charging module 14 comprises a cooling module 17 in the middle of the primary-side charging module 14.

FIG. 8 shows a schematic sectional view of a part of an exemplary embodiment of the primary-side charging module 14 and a part of an exemplary embodiment of the secondary-side charging module 36. A primary coil 13 is arranged in the primary-side charging module 14 and connected to a converter 22. The converter 22 can be connected to the back-up battery 26. An iron core 34 is arranged in the primary coil 13, which extends in the form of a horseshoe. The cooling module 17 of the primary-side charging module 14 is in thermal contact with a contact area 23 of the secondary-side charging module 36. The contact area 23 is in thermal contact with the battery 11 of the vehicle 12 to cool or heat said battery. A secondary coil 20 is arranged in the secondary-side charging module 36 and connected to a transformer 22. The converter 22 can be connected to the battery 11 of the vehicle 12. An iron core 34 is also arranged in the secondary coil 20.

In FIG. 8, the primary-side charging module 14 is in the charging position. In this position, an imaginary connecting axis through the primary coil 13 and the secondary coil 20 encloses an angle with the base area of the primary-side charging module 14 of greater than 0° and less than 90°. The surface 38 of the primary-side charging module 14 is in direct contact with the secondary-side charging module 36. An air gap 25 remains between the side surfaces 15 of the primary-side charging module 14 and the side surfaces 21 of the secondary-side charging module 36.

FIG. 9 shows a schematic sectional view of a part of another exemplary embodiment of the primary-side charging module 14 and a part of another exemplary embodiment of the secondary-side charging module 36. The primary-side charging module 14 is arranged in a ring shape between two parts of the secondary-side charging module 36. Two primary coils 13 are arranged in the primary-side charging module 14. A secondary coil 20 is arranged in the outer part of the secondary-side charging module 36. The inner part of the secondary-side charging module 36 is laterally surrounded by the primary-side charging module 14. A further secondary coil 20 is arranged in the inner part of the secondary-side charging module 36. During charging, one of the primary coils 13 can transmit energy to the secondary coil 20 in the outer part of the secondary-side charging module 36, and the other primary coil 13 can transmit energy to the secondary coil 20 in the inner part of the secondary-side charging module 36. This exemplary embodiment enables a compact arrangement of the primary-side charging module 14 and the secondary-side charging module 36.

1. A primary-side charging device (10) for charging a battery (11) for a vehicle (12) having an electric drive (37), comprising:
at least one primary coil (13), and
a primary-side charging module (14) in which the primary coil (13) is arranged, wherein
the primary-side charging module (14) has at least three side surfaces (15) and each of the side surfaces (15) encloses an angle of greater than 0° and not more than 90° with a base area of the primary-side charging module (14), and
the at least one primary coil (13) is connected to a power supply unit (16).

2. The primary-side charging device (10) according to claim 1, wherein the primary-side charging module (14) has a shape which is complementary to a secondary-side charging module (36).

3. The primary-side charging device (10) according to claim 1, in which the at least three side surfaces (15) of the primary-side charging module (14) form side surfaces of a truncated pyramid or truncated cone.

4. The primary-side charging device (10) according to claim 1, in which each primary coil (13) can be separately controlled by the power supply unit (16).

5. The primary-side charging device (10) according to claim 1, in which a cooling module (17) is arranged in the primary-side charging module (14).

6. The primary-side charging device (10) according to claim 1, comprising an adjusting part (18) having the primary-side charging module (14), the adjusting part (18) being able to be moved in at least one adjustment direction (z).

7. A secondary-side charging device (19) for charging a battery (11) for a vehicle (12) having an electric drive (37), comprising:
at least one secondary coil (20), and
a secondary-side charging module (36) in which the secondary coil (20) is arranged, wherein
the secondary-side charging module (36) has at least three side surfaces (21) and each of the side surfaces (21) encloses an angle of greater than 0° and not more than 90° with a base area of the secondary-side charging module (36), and
the at least one secondary coil (20) is electrically coupled to the battery (11) of the vehicle (12).

8. The secondary-side charging device (19) according to claim 7, in which the secondary-side charging module (36) has a shape which is complementary to a primary-side charging module (14).

9. The secondary-side charging device (19) according to claim 7, in which the at least three side surfaces (21) of the secondary-side charging module (36) form side surfaces of a truncated pyramid or truncated cone.

10. The secondary-side charging device (19) according to claim 7, in which each secondary coil (20) is coupled to a converter (22).

11. The secondary-side charging device (19) according to claim 7, in which the secondary-side charging module (36) has a contact area (23) which is thermally coupled to the battery (11).

12. The secondary-side charging device (19) according to claim 7, comprising an adjusting part (18) having the secondary-side charging module (36), the adjusting part (18) being able to be moved in at least one adjustment direction (z).

13. A charging system (24) for charging a battery (11) for a vehicle (12) having an electric drive (37), comprising:
a primary-side charging device (10) according to claim 1, and
a secondary-side charging device (19) according to claim 7.

14. The charging system (24) according to claim 13, in which an air gap (25) remains between the primary-side charging module (14) and the secondary-side charging module (36) during charging the battery (11).

15. The charging system (24) according to claim 13, in which the at least one primary coil (13) has a number of windings which differs from that of the at least one secondary coil (20).

16. The charging system (24) according to claim 13, in which the cooling module (17) and the contact area (23) are in thermal contact during charging the battery (11).

17. A method of charging a battery (11) for a vehicle (12) having an electric drive (37), comprising the steps of:
positioning a primary-side charging module (14) having at least one primary coil (13) and positioning a secondary-side charging module (36) having at least one secondary coil (20),
applying an AC voltage to the at least one primary coil (13), and
converting an AC voltage induced in the at least one secondary coil (20) into a DC voltage for charging the battery (11), wherein
the at least one primary coil (13) is connected to a power supply unit (16),
the at least one secondary coil (20) is electrically coupled to the battery (11) of the vehicle (12),
the primary-side charging module (14) has at least three side surfaces (15) and each of the side surfaces (15) encloses an angle of greater than 0° and not more than 90° with a base area of the primary-side charging module (14),
the secondary-side charging module (36) has at least three side surfaces (21) and each of the side surfaces (21) encloses an angle of greater than 0° and not more than 90° with a base area of the secondary-side charging module (36), and
the side surfaces (15) of the primary-side charging module (14) are adapted to the side surfaces (21) of the secondary-side charging module (36) so that an air gap (25) remains between the primary-side charging module (14) and the secondary-side charging module (36) during charging the battery (11).

18. The method according to claim 17, in which a cooling module (17) is arranged in the primary-side charging module (14) and a contact area (23) is arranged in the secondary-side charging module (36), with the contact area (23) being thermally coupled to the battery (11) and the cooling module (17) and the contact area (23) being in thermal contact during charging the battery (11).
